(19) United States
(12) Patent Application Publication
(10) Pub. No.: US 2026/0197579 A1
(43) Pub. Date: Jul. 9, 2026

(54) ELECTRONIC DEVICE HAVING A MICROPHONE AND METHOD FOR CONTROLLING THE SAME

(71) Applicant: LG ELECTRONICS INC., Seoul (KR)

(72) Inventors: Dongsung SHIN, Seoul (KR); Minwoo KIM, Seoul (KR)

(73) Assignee: LG ELECTRONICS INC., Seoul (KR)

(21) Appl. No.: 19/180,566

(22) Filed: Apr. 16, 2025

(30) Foreign Application Priority Data
Jan. 8, 2025 (WO) PCT/KR2025/000422

(51) Int. Cl. H04R 3/00; G10K 11/178

(52) U.S. Cl. CPC H04R 3/005; G10K 11/17823

(57) ABSTRACT

Disclosed are an electronic device and method for controlling the same that may increase the performance of sensing and recognizing a user's voice even in ambient noise by installing an Air Conduction Microphone (ACM) and a Bone Conduction Microphone (BCM) together and selectively using at least one of the ACM and the BCM depending on a use environment, the electronic device including a user input unit, an Air Conduction Microphone (ACM), a Bone Conduction Microphone (BCM), and a controller configured to execute an application, detect a voice activity of a user based on a BCM sensing signal received from the BCM, and control a mixing signal generated by synthesizing the BCM sensing signal and an ACM sensing signal received from the ACM to be inputted to the application in response to detecting the voice activity.

### CROSS-REFERENCE TO RELATED APPLICATIONS

Pursuant to 35 U.S.C. § 119, this application claims the benefit of earlier filing date and right of priority to International Application No. PCT/KR2025/000422, filed on Jan. 8, 2025, the contents of which are all hereby incorporated by reference herein in their entireties.

### BACKGROUND OF THE DISCLOSURE

### Field of the Disclosure

The present disclosure relates to an electronic device having a microphone for receiving ambient sound and/or user voice and method for controlling the same.

### Discussion of the Related Art

Virtual Reality (VR) refers to a specific environment, situation, or technology itself that is similar to reality created by artificial technology using computers or the like, but is not real.

Augmented Reality (AR) refers to a technology that synthesizes virtual objects or information in a real environment and makes them look like objects existing in an original environment.

Mixed Reality (MR) or hybrid reality refers to creating a new environment or new information by combining a virtual world and a real world. In particular, it is called mixed reality when it refers to something that can interact in real time between a thing existing in reality and a thing existing in virtual reality.

In this case, a created virtual environment, situation, or the like stimulates user's five senses and allows them to freely enter and exit the boundary between reality and imagination by allowing them to experience space and time similar to the real thing. In addition, users may not only simply immerse themselves in this environment, but also interact with things implemented in this environment, such as manipulating or issuing commands using a real device.

Recently, research on gears used in these technical fields has been actively conducted.

There are two main types of wearable displays that implement images in the air. There are a helmet structure and a glasses-type structure worn on a head. In order to implement a large image by expanding a Field Of View (FOV), the helmet structure has a structure that is overall worn on a head due to an increased volume of an optical lens system structure, and the etymology of Head Mounted Display (HMD) was generated. Therefore, the helmet structure is utilized in the fields used in specialized and low-mobility limited spaces such as military training (cyber flight operation), cyber games, etc.

On the other hand, the glasses-type structure is composed of a small size with a viewing structure across a nose and ears like a glasses structure, so it is light and small to facilitate use even in a moving environment.

A microphone for receiving an input of a user's voice may be mounted in an electronic device such as a wearable display. However, when there is ambient noise such as wind noise, a user voice that is received through a microphone may not be properly sensed due to the ambient noise. Therefore, it is necessary to continue researching a method so that a user voice received through a microphone may be properly sensed and recognized even when there is ambient noise.

### SUMMARY OF THE DISCLOSURE

To solve the problems, one object of the present disclosure is to provide an electronic device and method for controlling the same that may increase the performance of sensing and recognizing a user's voice even in ambient noise by installing an Air Conduction Microphone (ACM) and a Bone Conduction Microphone (BCM) together and selectively using at least one of the ACM and the BCM depending on a use environment.

Additional advantages, objects, and features of the disclosure will be set forth in the disclosure herein as well as the accompanying drawings. Such aspects may also be appreciated by those skilled in the art based on the disclosure herein.

To achieve these and other advantages and in accordance with the purpose of the present disclosure as embodied and broadly described, in one technical aspect of the present disclosure, provided is an electronic device including a user input unit, an Air Conduction Microphone (ACM), a Bone Conduction Microphone (BCM), and a controller configured to execute an application, detect a voice activity of a user based on a BCM sensing signal received from the BCM, and control a mixing signal generated by synthesizing the BCM sensing signal and an ACM sensing signal received from the ACM to be inputted to the application in response to detecting the voice activity.

In response to failing to detect the voice activity of the user based on the BCM sensing signal received from the BCM, the controller may control a mute signal to be inputted to the application.

Based on no signal similarity between a low frequency band of the BCM sensing signal and a low frequency band of the ACM sensing signal, the controller may control the mixing signal to be inputted to the application.

The controller may control the mixing signal to be generated by synthesizing a low frequency component equal to or smaller than the reference frequency in the BCM sensing signal and a high frequency component greater than the reference frequency in the ACM sensing signal.

The reference frequency may be lower than a maximum sound reception frequency of the BCM and higher than a cutoff frequency of a low pass filter for filtering the low frequency band of the BCM sensing signal.

The controller may be configured to divide the BCM sensing signal of a frequency domain into a plurality of frequency bands having a predetermined frequency band interval with each other, calculate an average energy of each of the frequency bands, and select the reference frequency variably based on an average energy difference between two neighboring frequency bands.

The controller may control the ACM sensing signal to be inputted to the application in response to a user command inputted through the user input unit in the course of inputting the mixing signal to the application.

Based on the signal similarity existing between the low frequency band of the BCM sensing signal and the low frequency band of the ACM sensing signal, the controller may control the ACM sensing signal to be inputted to the application.

The controller may control the mixing signal to be inputted to the application in response to a user command inputted through the user input unit in the course of inputting the ACM sensing signal to the application.

In another technical aspect of the present disclosure, provided is a method of controlling an electronic device, the method including executing an application, detecting a voice activity of a user based on a Bone Conduction Microphone (BCM) sensing signal received from the BCM, and inputting a mixing signal generated by synthesizing the BCM sensing signal and an Air Conduction Microphone (ACM) sensing signal received from the ACM to the application in response to detecting the voice activity.

The effect of an electronic device having a microphone and method for controlling the same according to the present disclosure is described as follows.

According to at least one of various aspects of the present disclosure, an electronic device includes an Air Conduction Microphone (ACM) and a Bone Conduction Microphone (BCM), thereby having the advantage of being able to sense and recognize user voice even in ambient noise by selectively using at least one of an ACM and a BCM depending on a use environment.

Effects obtainable from the present disclosure may be non-limited by the above-mentioned effects. And, other unmentioned effects can be clearly understood from the following description by those having ordinary skill in the technical field to which the present disclosure pertains.

### BRIEF DESCRIPTION OF THE DRAWINGS

The present disclosure will become more fully understood from the detailed description given herein below and the accompanying drawings, which are given by illustration only, and thus are not limitative of the present disclosure.

FIG. 1 is a block diagram illustrating an electronic device according to one aspect of the present disclosure.

FIG. 2 is a block diagram illustrating a microphone and a controller of FIG. 1.

FIGS. 3 to 5 are flowcharts of a control method executable in an electronic device according to one aspect of the present disclosure.

FIG. 6 is a flowchart for variably setting a reference frequency of FIG. 5.

FIG. 7 is an example graph of a reference frequency variably set according to one aspect of the present disclosure.

FIG. 8 is a diagram illustrating a modification of the control methods of FIG. 4 and FIG. 5.

### DETAILED DESCRIPTION OF THE DISCLOSURE

Description will now be given in detail according to exemplary aspects disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well known to one of ordinary skill in the relevant art has generally been omitted for the sake of brevity. The accompanying drawings are used to help easily understand various technical features and it should be understood that the aspects presented herein are not limited by the accompanying drawings. As such, the present disclosure should be construed to extend to any alterations, equivalents and substitutes in addition to those which are particularly set out in the accompanying drawings.

Each of these elements may be configured as a separate individual hardware module or implemented as two or more hardware modules. Two or more elements may be implemented as a single hardware module. In some cases, at least one of these elements may be implemented as software.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

In this disclosure, the expression “at least one of A or B” may mean “A”, “B”, or “A and B”.

Electronic devices presented herein may be implemented using a variety of different types of terminals. Examples of such terminals include cellular phones, smart phones, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs), earbuds), and the like.

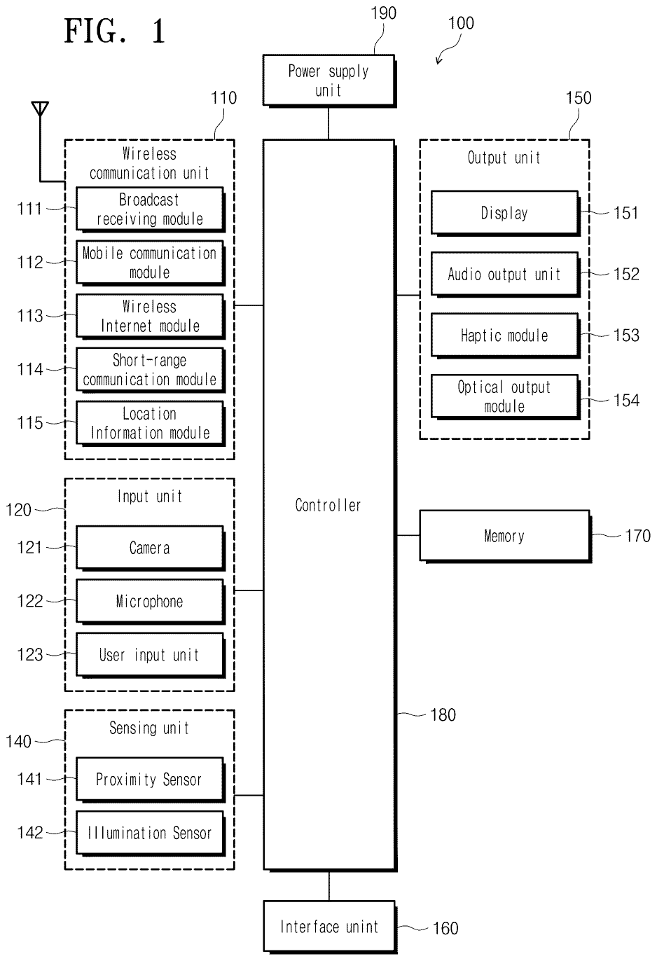

Reference is now made to FIG. 1, which is a block diagram of a user terminal in accordance with the present disclosure.

The user terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the user terminal 100 is shown having wireless communication unit 110 configured with several commonly implemented components. For instance, the wireless communication unit 110 typically includes one or more components which permit wireless communication between the user terminal 100 and a wireless communication system or network within which the user terminal is located.

The wireless communication unit 110 typically includes one or more modules which permit communications such as wireless communications between the user terminal 100 and a wireless communication system, communications between the user terminal 100 and another user terminal, communications between the user terminal 100 and an external server. Further, the wireless communication unit 110 typically includes one or more modules which connect the user terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the user terminal, the surrounding environment of the user terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The user terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the user terminal 100 and a user, as well as function as the user input unit 123 which provides an input interface between the user terminal 100 and the user.

The interface unit 160 serves as an interface with various types of external devices that can be coupled to the user terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the user terminal 100 may perform assorted control functions associated with a connected external device, in response to the external device being connected to the interface unit 160.

The memory 170 is typically implemented to store data to support various functions or features of the user terminal 100. For instance, the memory 170 may be configured to store application programs executed in the user terminal 100, data or instructions for operations of the user terminal 100, and the like. Some of these application programs may be downloaded from an external server via wireless communication. Other application programs may be installed within the user terminal 100 at time of manufacturing or shipping, which is typically the case for basic functions of the user terminal 100 (for example, receiving a call, placing a call, receiving a message, sending a message, and the like). It is common for application programs to be stored in the memory 170, installed in the user terminal 100, and executed by the controller 180 to perform an operation (or function) for the user terminal 100.

The controller 180 typically functions to control overall operation of the user terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the user terminal 100. The power supply unit 190 may include a battery, and the battery may be configured to be embedded in the terminal body, or configured to be detachable from the terminal body.

At least some of the components may operate in cooperation with each other to implement an operation, control, or a control method of the user terminal according to various embodiments to be described below. In addition, the operation, the control, or the control method of the user terminal may be implemented on the user terminal by driving at least one application program stored in the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the user terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external user terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE), LTE-A(Long Term Evolution-Advanced), 5G, and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the user terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A, 5G and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the user terminal 100 and a wireless communication system, communications between the user terminal 100 and another user terminal 100, or communications between the user terminal and a network where another user terminal 100 (or an external server) is located, via wireless area networks. One example of the wireless area networks is a wireless personal area networks.

In some embodiments, another user terminal (which may be configured similarly to user terminal 100) may be a wearable device, for example, a smart watch, a smart glass or a head mounted display (HMD), which is able to exchange data with the user terminal 100 (or otherwise cooperate with the user terminal 100). The short-range communication module 114 may sense or recognize the wearable device, and permit communication between the wearable device and the user terminal 100. In addition, when the sensed wearable device is a device which is authenticated to communicate with the user terminal 100, the controller 180, for example, may cause transmission of data processed in the user terminal 100 to the wearable device via the short-range communication module 114. Hence, a user of the wearable device may use the data processed in the user terminal 100 on the wearable device. For example, when a call is received in the user terminal 100, the user may answer the call using the wearable device. Also, when a message is received in the user terminal 100, the user can check the received message using the wearable device.

The location information module 115 is generally configured to detect, calculate, derive or otherwise identify a position of the user terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the user terminal. As one example, when the user terminal uses a GPS module, a position of the user terminal may be acquired using a signal sent from a GPS satellite. As another example, when the user terminal uses the Wi-Fi module, a position of the user terminal can be acquired based on information related to a wireless access point (AP) which transmits or receives a wireless signal to or from the Wi-Fi module.

The input unit 120 may be configured to permit various types of input to the user terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the user terminal 100. As another example, the cameras 121 may be located in a stereoscopic arrangement to acquire left and right images for implementing a stereoscopic image. The plurality of cameras 121 may include a depth camera and/or a time of flight (TOF) camera for three-dimensionally sensing a subject.

The microphone 122 is generally implemented to permit audio input to the user terminal 100. The audio input can be processed in various manners according to a function being executed in the user terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the user terminal 100. The user input unit 123 may include one or more of a mechanical input element (for example, a key, a button located on a front and/or rear surface or a side surface of the user terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the user terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the user terminal, surrounding environment information of the user terminal, user information, or the like. The controller 180 generally cooperates with the sending unit 140 to control operation of the user terminal 100 or execute data processing, a function or an operation associated with an application program installed in the user terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the user terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the user terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the user terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the user terminal 100. For example, the display unit 151 may display execution screen information of an application program executing at the user terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the user terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the user terminal 100.

An optical output module 154 can output a signal for indicating an event generation using light of a light source. Examples of events generated in the user terminal 100 may include message reception, call signal reception, a missed call, an alarm, a schedule notice, an email reception, information reception through an application, and the like.

A signal output by the optical output module 154 may be implemented in such a manner that the user terminal emits monochromatic light or light with a plurality of colors. The signal output may be terminated as the user terminal senses that a user has checked the generated event, for example.

The interface unit 160 serves as an interface for external devices to be connected with the user terminal 100. For example, the interface unit 160 can receive data transmitted from an external device, receive power to transfer to elements and components within the user terminal 100, or transmit internal data of the user terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the user terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the user terminal 100 is connected with an external cradle, the interface unit 160 can serve as a passage to allow power from the cradle to be supplied to the user terminal 100 or may serve as a passage to allow various command signals input by the user from the cradle to be transferred to the user terminal there through. Various command signals or power input from the cradle may operate as signals for recognizing that the user terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The user terminal 100 may also be operated in relation to a network storage device that performs the storage function of the memory 170 over a network, such as the Internet.

The controller 180 may typically control the general operations of the user terminal 100. For example, the controller 180 may set or release a lock state for restricting a user from inputting a control command with respect to applications when a status of the user terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the user terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

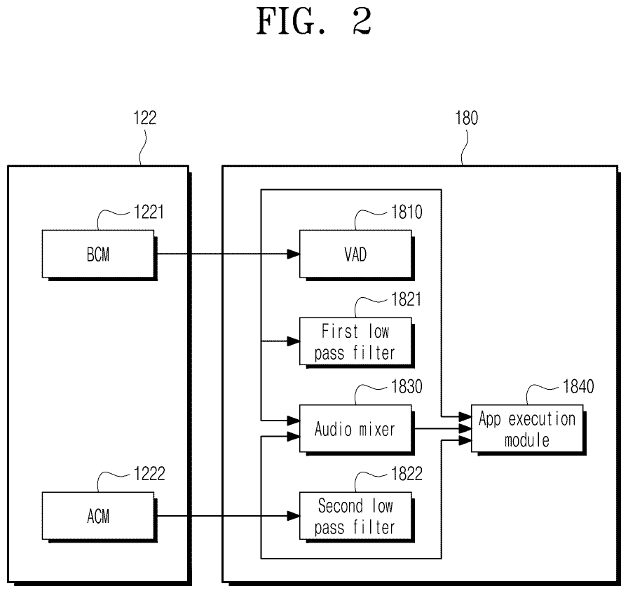

Hereinafter, the microphone 122 and the controller 180 will be described in more detail with reference to FIG. 2. FIG. 2 is a block diagram illustrating the microphone and the controller of FIG. 1.

The microphone 122 may include at least one Bone Conduction Microphone (BCM) 1221 and at least one Air Conduction Microphone (ACM) 1222. The ACM is a microphone that senses sound through vibration of air, and the BCM is a microphone that senses sound through vibration of bone of a user.

The ACM and the BCM may have different sound-receiving frequency characteristics. The ACM receives sound well in all audible frequency bands, but the BCM has a limited sound-receiving frequency bandwidth (e.g., 2 kHz or less) than the ACM. However, in a use environment where there is a lot of wind or environmental noise, the ACM may inevitably suffer from performance degradation over the BCM due to differences in sound propagation media. Therefore, when at least one of the ACM 1221 and the BCM 1222 is appropriately and selectively used according to a use environment, the electronic device 100 may accurately receive a desired sound even in various use environments.

The controller 180 may include a Voice Activity Detector (VAD) 1810, a first low pass filter 1821, a second low pass filter 1822, an audio mixer 1830, and an app execution module 1840. Although the components are shown as included in the controller 180 in FIG. 2, it is a matter of course that at least one of them may be configured as an entity separate from the controller 180. And each of the components may be configured in hardware or software.

The VAD 1810 may detect whether a user is speaking based on a sensing signal of the BCM 1221. For example, in response to the BCM 1221 that senses a bone vibration over a prescribed magnitude, the VAD 1810 may detect that the user is currently speaking.

The first low pass filter 1821 may low-pass-filter a sensing signal of the BCM 1221, and the second low pass filter 1822 may low-pass-filter a sensing signal of the ACM 1222. Blocking frequencies of the first low pass filter 1821 and the second low pass filter 1822 may be the same within a predetermined range. The blocking frequencies of the first low pass filter 1821 and the second low pass filter 1822 may be smaller than a maximum sound reception frequency of the BCM 1221. For example, the blocking frequencies of the first low pass filter 1821 and the second low pass filter 1822 may be 1 kHz. The first low pass filter 1821 and the second low pass filter 1822 may be further designed so that a component less than or equal to 100 Hz does not pass.

The audio mixer 1810 may mix a BCM sensing signal of the BCM 1221 and an ACM sensing signal of the ACM 1222, and provide the mixed signal to the app execution module 1840. For example, the audio mixer 1810 may mix a first frequency component less than (or equal to) a reference frequency (Fc) among total frequency components of the BCM sensing signal and a second frequency component greater than or equal to (or greater than) the reference frequency (Fc) among total frequency components of the ACM sensing signal. The mixing of the BCM sensing signal and the ACM sensing signal will be described later.

The app execution module 1840 may refer to a module (or an application itself) that processes a currently executed application related to a user's speech in the electronic device 100. For example, when the electronic device 100 is executing a phone call application, the app execution module 1840 may refer to a module that processes a phone call function. Alternatively, when the electronic device 100 is executing a voice recognition application, the app execution module 1840 may refer to a module that processes a voice recognition function. Accordingly, the app execution module 1840 may vary according to which application is currently being executed in the electronic device 100.

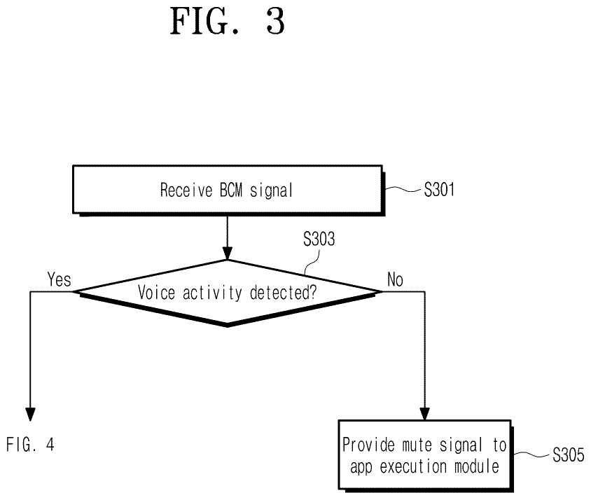

The app execution module 1840 may receive only an ACM sensing signal according to a use environment and apply it to a currently executed application, or may receive a mixing signal of a BCM sensing signal and an ACM sensing signal and apply it to a currently executed application. This will be described further with reference to FIGS. 3 to 5. FIGS. 3 to 5 are flowcharts of a control method executable in an electronic device according to one aspect of the present disclosure.

First, the controller 180 may receive a BCM sensing signal from the BCM 1221 [S301].

And, the controller 180 may analyze the BCM sensing signal through the VAD 1810 to detect whether there is a voice activity of a user (i.e., whether the user is speaking) [S303].

When it is determined that there is no voice activity of the user, the controller 180 may control neither the BCM sensing signal nor the ACM sensing signal to be inputted to the app execution module 1840 [S305]. Alternatively, when there is no voice activity of the user, the controller 180 may control to generate a mute signal and input the mute signal to the app execution module 1840 [S305].

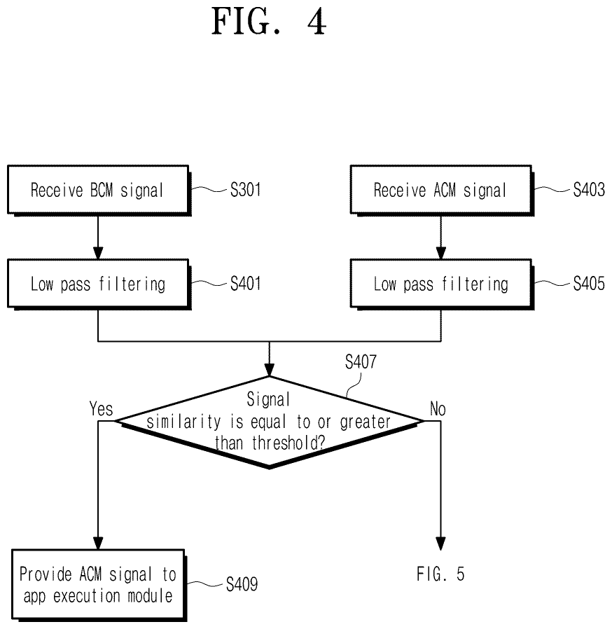

When it is determined that the voice activity of the user exists, the present process may be performed according to FIG. 4. This will be described further with reference to FIG. 4.

The controller 180 may receive a BCM sensing signal from the BCM 1221 [S301].

The controller 180 may perform low pass filtering on the BCM sensing signal through the first low pass filter 1821 [S401].

Meanwhile, the controller 180 may receive an ACM sensing signal from the ACM 1222 [S403]. The ACM sensing signal may be a signal sensed at the same timing point as the BCM sensing signal or within a predetermined time range from the timing point at which the BCM sensing signal is sensed.

The controller 180 may perform low pass filtering on the ACM sensing signal through the second low pass filter 1822 [S405].

The controller 180 may store (or buffer) the ACM sensing signal and the BCM sensing signal at predetermined time intervals (e.g., 10 ms), respectively, for frequency analysis and the like.

The controller 180 may perform hamming window processing on the ACM sensing signal and the BCM sensing signal by overlapping them in at least a portion (e.g., 5 ms) of a predetermined time interval to prevent frequency leakage.

The controller 180 may determine whether the similarity between the low-pass-filtered BCM sensing signal and the low-pass-filtered ACM sensing signal is greater than or equal to a predetermined threshold [S407]. Based on the similarity, it may be determined whether there is ambient noise in a use environment of the electronic device 100.

A representative example of the ambient noise may be wind. Ambient noise such as wind may have little effect on the BCM sensing signal. However, ambient noise such as wind may have a great influence on the ACM sensing signal. In particular, wind noise may have a great influence on a low frequency band component of the ACM sensing signal. Accordingly, it is possible to determine whether the ACM sensing signal is contaminated by wind noise by comparing the similarity between the low-pass-filtered BCM sensing signal and the low-pass-filtered ACM sensing signal. If the similarity between the low-pass-filtered BCM sensing signal and the low-pass-filtered ACM sensing signal is high, it may be considered that the ACM sensing signal is not contaminated by wind noise. If the similarity is low, the ACM sensing signal may be considered to be contaminated by wind noise.

When the similarity between the low-pass-filtered BCM sensing signal and the low-pass-filtered ACM sensing signal is greater than or equal to (or exceeds) a prescribed threshold, the controller 180 may control the ACM sensing signal to be applied (or inputted) to the app execution module 1840 [S409]. When the similarity is greater than or equal to the prescribed threshold, it may be determined that there is no ambient noise in the use environment of the electronic device 100.

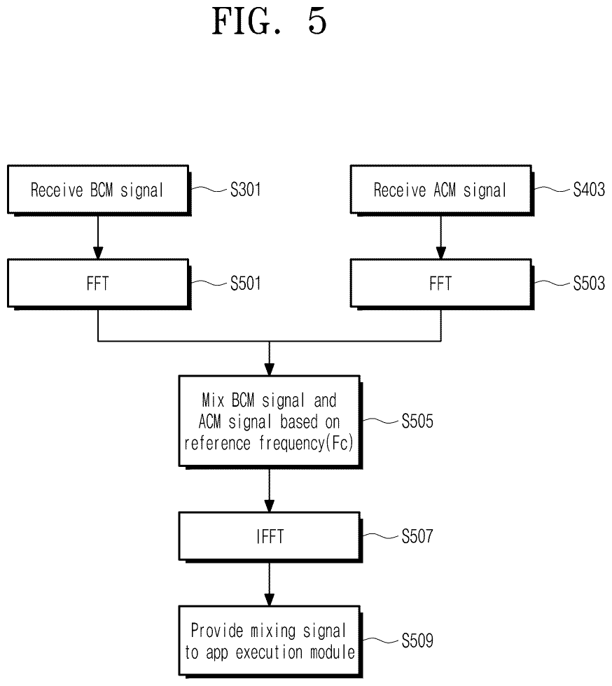

When the similarity between the low-pass-filtered BCM sensing signal and the low-pass-filtered ACM sensing signal is less than (or equal to or smaller than) the prescribed threshold, the present process may proceed according to FIG. 5. When the similarity is less than the prescribed threshold, it may be determined that there is ambient noise in the use environment of the electronic device 100. This will be described with reference to FIG. 5 further.

The controller 180 may receive a BCM sensing signal from the BCM 1221 [S301]. The BCM sensing signal may be based on the time domain.

The controller 180 may perform Fast Fourier Transform (FFT) on the BCM sensing signal to convert the BCM sensing signal in the time domain into the BCM sensing signal in the frequency domain [S501].

The controller 180 may receive an ACM sensing signal from the ACM 1222 [S401]. The ACM sensing signal may be based on the time domain.

The controller 180 may perform Fast Fourier Transform (FFT) on the ACM sensing signal to convert the ACM sensing signal in the time domain into the ACM sensing signal in the frequency domain [S503].

The controller 180 may mix the BCM sensing signal in the frequency domain and the ACM sensing signal in the frequency domain based on a reference frequency (Fc). The reference frequency (Fc) may be set to a fixed value (e.g., 1.5 Hz). The reference frequency (Fc) may be lower than a maximum sound reception frequency of the BCM 1221, and may be higher than the cutoff frequencies of the first low pass filter 1821 and the second low pass filter 1822. Alternatively, the reference frequency (Fc) may be variably set according to the BCM sensing signal. The reference frequency (F)c that is variably set will be described later.

The controller 180 may generate a mixed signal by mixing the BCM sensing signal and the ACM sensing signal by synthesizing a low frequency component lower than (or below) the reference frequency (Fc) in the BCM sensing signal and a high frequency component exceeding (or equal to or higher than) the reference frequency (Fc) in the ACM sensing signal. That is, in the mixing signal, a low frequency band lower than the reference frequency (Fc) may be composed of the BCM sensing signal, and a high frequency band higher than the reference frequency (Fc) may be composed of the ACM sensing signal.

The controller 180 may perform Inverse Fast Forwarder Transform (IFFT) on the mixing signal to control the mixing signal of the frequency domain to be converted into the mixing signal of the time domain [S507].

The controller 180 may control the time-domain mixing signal to be applied (or inputted) to the app execution module 1840 [S509]. The controller 180 may input it to the app execution module 1840 in a manner that at least a portion (e.g., 5 ms) of a prescribed time interval is overlapped in order to eliminate discontinuity between frames.

Accordingly, the electronic device 100 according to the present disclosure may improve a recognition rate of a user's voice not only in a quiet indoor environment but also in an outdoor environment where wind distortion is severe or noisy, and may transmit a clean user voice to the other party even during a phone call.

In FIG. 4 and FIG. 5, it has been described that if the similarity between the low-pass-filtered BCM sensing signal and the low-pass-filtered ACM sensing signal is equal to or greater than (or above) a prescribed threshold, the ACM sensing signal is applied (or inputted) to the app execution module 1840, and if the similarity between the low-pass-filtered BCM sensing signal and the low-pass-filtered ACM sensing signal is smaller than (or below) the prescribed threshold, the mixing signal of the time domain is applied (or inputted) to the app execution module 1840.

However, the present disclosure is not limited thereto. For example, without determining whether the similarity between the low-pass-filtered BCM sensing signal and the low-pass-filtered ACM sensing signal is greater than or equal to the prescribed threshold, the mixing signal of the time domain may be applied (or inputted) to the app execution module 1840. That is, when it is determined that there is a voice activity of a user, the process may proceed directly according to FIG. 5 by skipping FIG. 4.

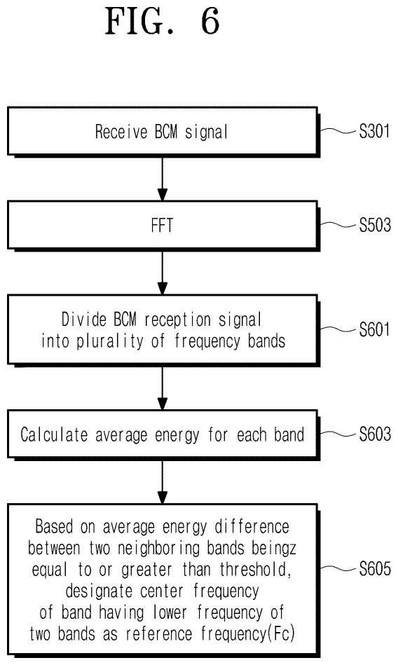

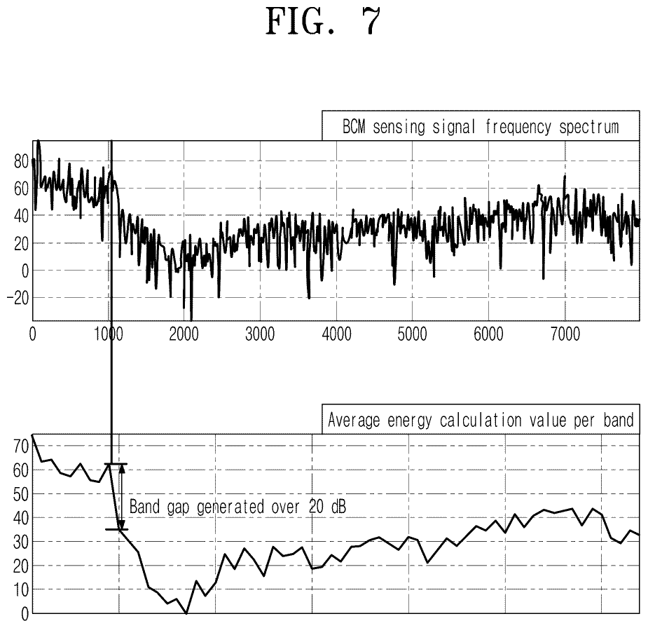

Hereinafter, referring to FIG. 6 and FIG. 7, a reference frequency (Fc) variably set according to a BCM sensing signal will be described. Since a maximum effective frequency of a BCM varies according to a state in which a user wears the electronic device 100, the reference frequency (Fc) may be variably set by considering the same. FIG. 6 is a flowchart of variably setting the reference frequency of FIG. 5. FIG. 7 is a graph of an example of a reference frequency variably set according to one aspect of the present disclosure.

The controller 180 may receive a BCM sensing signal from the BCM 1221 [S301].

The controller 180 may perform Fast Fourier Transform (FFT) on the BCM sensing signal to convert the BCM sensing signal in the time domain into the BCM sensing signal in the frequency domain [S503].

The controller 180 may divide the BCM sensing signal of the frequency domain into a plurality of frequency bands having a constant frequency band interval with each other [S601]. For example, the controller 180 may divide the BCM sensing signal of the frequency domain into 12 frequency bands from 800 Hz to 2 kHz in a unit of 100 Hz.

The controller 180 may calculate an average energy of each of the frequency bands [S603].

The controller 180 may sequentially determine whether an average energy difference between two neighboring frequency bands is greater than or equal to (or exceeds) a threshold by starting with a minimum frequency band. The average energy difference may be calculated by subtracting the average energy of a higher frequency one of the two neighboring frequency bands from the average energy of a lower frequency one of the two neighboring frequency bands. A frequency (e.g., center frequency of the low band) belonging to a lower frequency one of two neighboring frequency bands determined first as having an average energy difference equal to or greater than a threshold may be selected as a reference frequency (Fc) [S605].

Referring to FIG. 6, it is illustrated that the average energy of the frequency band of 1.2 kHz to 1.4 kHz is smaller than or equal to the average energy of the frequency band of 1.0 kHz to 1.2 kHz by a threshold (e.g., 20 dB) or more. In this case, the reference frequency (Fc) may be selected as a center frequency (1.1 kHz) of the frequency band of 1 kHz to the frequency band of 1.2 kHz.

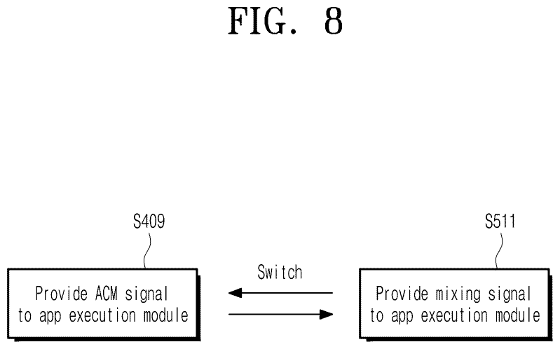

In FIG. 4 and FIG. 5, it has been described that one of the ACM sensing signal and the mixing signal is automatically selected based on the signal similarity and is then inputted to the app execution module 1840. However, one of the ACM sensing signal and the mixing signal may be selected by a user and then inputted to the app execution module 1840. This will be described further with reference to FIG. 8. FIG. 8 illustrates a modification of the control method of FIG. 4 and FIG. 5.

As described above, the controller 180 may control an ACM sensing signal to be applied (or inputted) to the app execution module 1840 [S409].

When a preset user command is inputted through the user input unit 123 while the ACM sensing signal is applied to the app execution module 1840, the controller 180 may control a mixing signal to be applied to the app execution module 1840 instead of the ACM sensing signal [S511].

Meanwhile, the controller 180 may control the mixing signal to be applied (or inputted) to the app execution module 1840 [S511].

When a preset user command is inputted through the user input unit 123 while the mixing signal is applied to the app execution module 1840, the controller 180 may control the ACM sensing signal to be applied to the app execution module 1840 instead of the mixing signal [S40]).

The present disclosure described above may be implemented with computer-readable codes on a medium in which a program is recorded. Computer-readable media include all kinds of recording devices in which data readable by a computer system is stored. Examples of computer-readable media include a hard disk drive (HDD), a solid state disk (SSD), a silicon disk drive (SDD), a ROM, a RAM, a CD-ROM, a magnetic tape, a floppy disk, an optical data storage device, and the like.

What is claimed is:

1. An electronic device, comprising:
a user input unit;
an Air Conduction Microphone (ACM);
a Bone Conduction Microphone (BCM); and
a controller configured to execute an application, detect a voice activity of a user based on a BCM sensing signal received from the BCM, and control a mixing signal generated by synthesizing the BCM sensing signal and an ACM sensing signal received from the ACM to be inputted to the application in response to detecting the voice activity.

2. The electronic device of claim 1, wherein in response to failing to detect the voice activity of the user based on the BCM sensing signal received from the BCM, the controller controls a mute signal to be inputted to the application.

3. The electronic device of claim 1, wherein based on no signal similarity between a low frequency band of the BCM sensing signal and a low frequency band of the ACM sensing signal, the controller controls the mixing signal to be inputted to the application.

4. The electronic device of claim 3, wherein the controller controls the mixing signal to be generated by synthesizing a low frequency component equal to or smaller than the reference frequency in the BCM sensing signal and a high frequency component greater than the reference frequency in the ACM sensing signal.

5. The electronic device of claim 4, wherein the reference frequency is lower than a maximum sound reception frequency of the BCM and higher than a cutoff frequency of a low pass filter for filtering the low frequency band of the BCM sensing signal.

6. The electronic device of claim 4, wherein the controller is configured to divide the BCM sensing signal of a frequency domain into a plurality of frequency bands having a predetermined frequency band interval with each other, calculate an average energy of each of the frequency bands, and select the reference frequency variably based on an average energy difference between two neighboring frequency bands.

7. The electronic device of claim 1, wherein the controller controls the ACM sensing signal to be inputted to the application in response to a user command inputted through the user input unit in the course of inputting the mixing signal to the application.

8. The electronic device of claim 3, wherein based on the signal similarity existing between the low frequency band of the BCM sensing signal and the low frequency band of the ACM sensing signal, the controller controls the ACM sensing signal to be inputted to the application.

9. The electronic device of claim 8, wherein the controller controls the mixing signal to be inputted to the application in response to a user command inputted through the user input unit in the course of inputting the ACM sensing signal to the application.

10. A method of controlling an electronic device, the method comprising:
executing an application;
detecting a voice activity of a user based on a Bone Conduction Microphone (BCM) sensing signal received from the BCM; and
inputting a mixing signal generated by synthesizing the BCM sensing signal and an Air Conduction Microphone (ACM) sensing signal received from the ACM to the application in response to detecting the voice activity.

11. The method of claim 10, comprising in response to failing to detect the voice activity of the user based on the BCM sensing signal received from the BCM, controlling a mute signal to be inputted to the application.

12. The method of claim 10, comprising based on no signal similarity between a low frequency band of the BCM sensing signal and a low frequency band of the ACM sensing signal, inputting the mixing signal to the application.

13. The method of claim 12, comprising generating the mixing signal by synthesizing a low frequency component equal to or smaller than the reference frequency in the BCM sensing signal and a high frequency component greater than the reference frequency in the ACM sensing signal.

14. The method of claim 13, wherein the reference frequency is lower than a maximum sound reception frequency of the BCM and higher than a cutoff frequency of a low pass filter for filtering the low frequency band of the BCM sensing signal.

15. The method of claim 13, comprising:
dividing the BCM sensing signal of a frequency domain into a plurality of frequency bands having a predetermined frequency band interval with each other;
calculating an average energy of each of the frequency bands; and
selecting the reference frequency variably based on an average energy difference between two neighboring frequency bands.
